(19) United States
(12) Patent Application Publication
(10) Pub. No.: US 2025/0305853 A1
(43) Pub. Date: Oct. 2, 2025

(54) HIGH-PRECISION INCLINOMETER TEMPERATURE COMPENSATION METHOD

(71) Applicant: SINOSTEEL MAANSHAN GENERAL INSTITUTE OF MINING RESEARCH CO., LTD, Ma'anshan City (CN)

(72) Inventors: Wen Nie, Ma'anshan City (CN); Bibo Dai, Ma'anshan City (CN); Yinhao Ren, Ma'anshan City (CN); Xuemin Zeng, Ma'anshan City (CN); Yunmin Wang, Ma'anshan City (CN); Tianqiang Zhu, Ma'anshan City (CN)

(73) Assignee: SINOSTEEL MAANSHAN GENERAL INSTITUTE OF MINING RESEARCH CO., LTD, Ma'anshan City (CN)

(21) Appl. No.: 18/978,933

(22) Filed: Dec. 12, 2024

(30) Foreign Application Priority Data
Mar. 29, 2024 (CN) 202410376783.7

(51) Int. Cl. G01C 25/00; G01C 9/02

(52) U.S. Cl. CPC G01C 25/00; G01C 9/02

(57) ABSTRACT

A high-precision inclinometer temperature compensation method is provided, including: acquiring original data of an inclinometer; and constructing a BP neural network model, optimizing the BP neural network model by adopting L-BFGS iterative optimization algorithm, and inputting the original data into an optimized BP neural network model to obtain a temperature compensation result of the inclinometer.

### CROSS-REFERENCE TO RELATED APPLICATIONS

This application claims priority to Chinese Patent Application No. 202410376783.7, filed on Mar. 29, 2024, the contents of which are hereby incorporated by reference.

### TECHNICAL FIELD

The present disclosure belongs to the technical field of temperature compensation, and in particular relates a high-precision inclinometer temperature compensation method.

### BACKGROUND

As an instrument for measuring the inclination of objects, inclinometer has been widely used in many fields such as engineering, geology, architecture and aviation. moreover, the inclinometer has the characteristics of small volume and low power consumption. However, the output precision of inclinometer will be affected by the ambient temperature, mainly because the internal scale factor and zero voltage of inclinometer will change with the temperature, thus affecting the output precision.

At present, there are many researches on temperature compensation methods of inclinometer, mainly using polynomial fitting method to fit the scale factor and zero voltage affected by temperature, so the output value of inclinometer is compensated for temperature. However, the precision of the method after compensation is not high, and the compensation effect is not significant, making it unsuitable for situations that require high-precision inclination data.

### SUMMARY

An objective of the present disclosure is to provide a high-precision inclinometer temperature compensation method, adopting a back propagation (BP) neural network-based temperature compensation model to perform temperature compensation on the output of the inclinometer and improve the output precision of the inclinometer.

In order to achieve the above objectives, the present disclosure provides the following scheme:
a high-precision inclinometer temperature compensation method, including:
acquiring original data of an inclinometer; and
inputting the original data into a BP neural network model to obtain a temperature compensation result of the inclinometer, where the BP neural network model is obtained by training a training set, and the training set includes an inclination value of the inclinometer, temperature and a corresponding inclinometer measurement value, and the BP neural network model is optimized by adopting Limited-Broyden Fletcher Goldfarb Shanno (L-BFGS) iterative optimization algorithm.

Optionally, steps before training the training set further includes preprocessing the training set: standardizing data in the training set by using Z-Score standardization method.

Optionally, constructing the BP neural network model includes:
setting a number of input nodes, a number of output nodes and a number of hidden layer nodes of the BP neural network model, taking MSE mean square error as a loss function of the BP neural network model, and adopting Rectified Linear Unit (ReLU) function as an activation function of the BP neural network model.

Optionally, a method of taking the MSE mean square error as the loss function of the BP neural network model is:

$$E = \frac{1}{n} {\sum }_{k = 1}^{n} {( {y}_{k} - {T}_{k} )}^{2} ,$$

where E is an error, n is a number of training samples, yₖ is a predicted value, and Tₖ is a true value.

Optionally, a method of adopting the ReLU function as the activation function of the BP neural network model is:

f(x)=max(0,x),
where f(x) is an output of the ReLU function, and x is an input value of the function.

Optionally, steps after constructing the BP neural network model include:
obtaining historical original data, preprocessing the historical original data, and inputting preprocessed historical original data into the BP neural network model for training; and
preprocessing the historical original data:

$$y = ( x - u ) / σ ,$$

where y is the standardized x data, is the original data, u is the average value of the original data and σ is the standard deviation of the original data.

Optionally, obtaining the temperature compensation result of the inclinometer includes:
inputting preprocessed original data into an optimized BP neural network model, and obtaining a conversion relationship among temperature, true inclination angle and inclination angle measurement value, and obtaining the temperature compensation result of the inclinometer according to the conversion relationship.

Optionally, the conversion relationship among the temperature, the true inclination angle and the inclination angle measurement value is:

y=f(x,t),
where y is a true inclination value, x is an output value of the inclinometer, t is the temperature, and f is a relation function learned by neural network.

The present disclosure has the following beneficial effects.

The BP neural network constructed by the present disclosure may adaptively adjust the model parameters, and has strong generalization ability, and may continuously improve the model performance in the training process. Compared with the polynomial fitting modeling mode, the neural network temperature compensation model may make the inclinometer more accurate.

In the present disclosure, the L-BFGS iterative optimization algorithm is adopted to optimize the model, so that the model may approach the optimal solution to the greatest extent in the training process and will not fall into the problem of local optimal solution.

### BRIEF DESCRIPTION OF THE DRAWINGS

In order to explain the embodiments of the present disclosure or the technical solution in the prior art more clearly, the drawings needed in the embodiments will be briefly introduced below. Apparently, the drawings in the following description are only some embodiments of the present disclosure. For one of ordinary skill in the art, other drawings may be obtained according to these drawings without paying creative labor.

FIG. 1 is a flowchart of a high-precision inclinometer temperature compensation method according to an embodiment of the present disclosure.

FIG. 2 is a verification diagram of temperature compensation effect according to an embodiment of the present disclosure.

FIG. 3 is a structural diagram of a temperature compensation data acquisition device according to an embodiment of the present disclosure.

### DETAILED DESCRIPTION OF THE EMBODIMENTS

In the following, the technical solutions in the embodiments of the present disclosure will be clearly and completely described with reference to the attached drawings. Apparently, the described embodiments are only a part of the embodiments of the present disclosure, but not all the embodiments. Based on the embodiments in the present disclosure, all other embodiments obtained by one of ordinary skill in the art without creative effort belong to the protection scope of the present disclosure.

In order to make the above objects, features and advantages of the present disclosure more obvious and easier to understand, the present disclosure will be further described in detail with the attached drawings and specific embodiments.

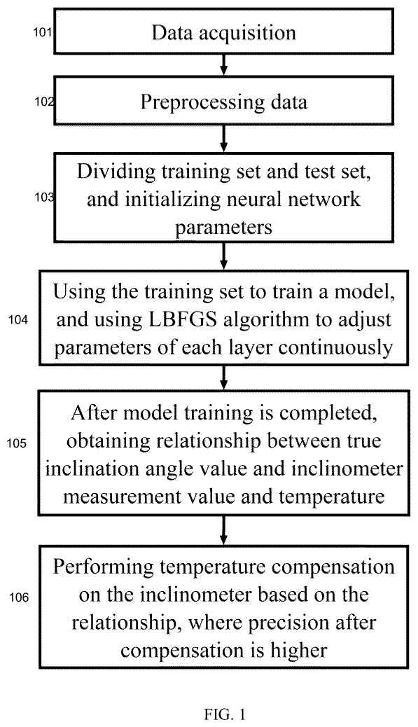

As shown in FIG. 1, the present disclosure discloses a high-precision inclinometer temperature compensation method, including the following steps: acquiring original data of an inclinometer; inputting the original data into a BP neural network model to obtain a temperature compensation result of the inclinometer, where the BP neural network model is obtained by training a training set, and the training set includes an inclination value of the inclinometer, temperature and a corresponding inclinometer measurement value, and the BP neural network model is optimized by L-BFGS iterative optimization algorithm.

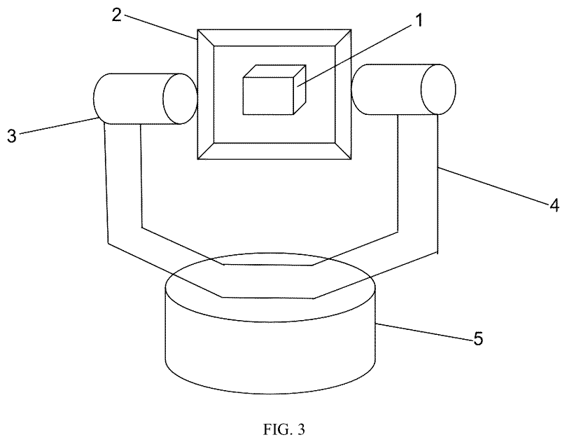

As shown in (1)-(5) in FIG. 3, the inclinometer is installed on the plane of the inner frame of the turntable, and then the turntable system is powered on and the temperature control mode of the turntable is started, and the inclinometer is started at the same time; the temperature inside the turntable is initially adjusted to −30° C. and allowed to stand for 30 min; then, at the temperature interval of 5° C., the temperature of the temperature control turntable is raised from −30° C. to 60° C. for collect data (101); the collected data are preprocessed (102), and the processed data are divided into test data and training data (103), and a BP neural network model is established; the training set is used to train the neural network model, the model parameters are adjusted, and the L-BFGS algorithm is used to optimize and improve the model (104); the relationship between the output value of inclinometer and the temperature to the true inclination value obtained after training (105): the uncompensated and compensated inclination data at different temperatures are collected to verify the compensation effect of the model; the original data of inclinometer include: true inclinometer value, temperature and inclinometer measurement value.

Data acquisition (101): firstly, the inclinometer is placed in the temperature control box of the three-axis temperature control turntable, and the rotating shaft is adjusted to make the inclinometer at the horizontal plane, that is, 0°; then, the temperature is continuously adjusted by using the three-axis temperature control turntable, and the temperature is gradually increased from −30° C. to 60° C. by 5° C., and then the inclinometer is allowed to stand for 30 min after each increase of 5° C., and then the true inclination value, temperature and inclinometer measurement value are collected; and
steps before training the training set also includes preprocessing the training set (102): standardizing data in the training set by using Z-Score standardization method.

Constructing the BP neural network model includes: setting a number of input nodes, a number of output nodes and a number of hidden layer nodes of the BP neural network model, taking MSE mean square error as a loss function of the BP neural network model, and adopting ReLU function as an activation function of the BP neural network model, specifically as follows.

Network parameters: since the input is temperature and the inclinometer measurement value and the output is the compensated inclination value, the number of input layer nodes is set to 2 and the number of output layer nodes is set to 1. Because the input layer has only two features, the number of hidden layer nodes is set to 1. In addition, the MSE mean square error is used as the loss function to calculate the difference between the predicted value and the true value, and the formula is:

$$E = \frac{1}{n} {\sum }_{k = 1}^{n} {( {y}_{k} - {T}_{k} )}^{2} ,$$

where E represents the error, n is the number of training samples, yₖ is the predicted value, and Tₖ is the true value. In order to ensure the performance and stability of the model, the initial weights and thresholds are initialized with small random numbers. The use of ReLU function for activation function may avoid the problem of gradient disappearance, and has faster calculation efficiency and convergence than other activation functions, and the formula is: f(x)=max (0, x),
where f(x) represents the output of ReLU function, and x represents the input value of the function. The function of ReLU function is to keep the output unchanged when the input is greater than 0, and to output 0 if the input is less than 0.

Establishment and optimization of the model: the training data set is used to train the model (104); BP neural network model is divided into two processes: forward propagation and back propagation; forward propagation means that the data is input from the input layer, and then multiplied by the corresponding weights along the direction of the network structure, and then summed up, and then the result is calculated in the activation function as an input, and the calculated result is passed as an input to the next node. Calculation is performed sequentially until the final result is obtained. Back propagation is a negative feedback process that compares the output result with the expected output result through the loss function, and uses the network to carry out back propagation of the error generated by the comparison. Through many iterations, the weights between nodes on the network are constantly adjusted. The gradient descent method is generally used to adjust the weights of neural networks. The core idea is to calculate the derivative of the loss function about the parameters, and then update the parameters along the opposite direction of the gradient. Therefore, the method requires manual calculation of the gradient of the loss function and is prone to getting stuck in local optimal solution. Therefore, this model adopts L-BFGS algorithm for optimization. The L-BFGS algorithm tries to approximate the inverse of the second-order matrix of the loss function in each iteration update, and compared with the gradient descent algorithm, there is no need to set the learning rate, because the algorithm will automatically adjust the learning rate according to the actual situation.

The L-BFGS algorithm attempts to approximate the inverse of the second-order matrix of the loss function in each iteration update, and the calculation formula is:

$${D}_{k + 1} = ( I - \frac{{s}_{k} {y}_{k}^{T}}{{y}_{k}^{T} {s}_{k}} ) {D}_{k} ( I - \frac{{y}_{k} {s}_{k}^{T}}{{y}_{k}^{T} {s}_{k}} ) + \frac{{s}_{k} {s}_{k}^{T}}{{y}_{k}^{T} {s}_{k}} ,$$

where, Dₖ is the inverse of the second-order matrix of the loss function of the current iteration, Sₖ is the difference of xₖ₊₁−xₖ, yₖ is the difference of gₖ₊₁−gₖ, where gₖ is the derivative function of the original function, that is, the gradient at the point xₖ, and in the iterative optimization calculation process, the values of Sₖ and yₖ are repeatedly calculated for updating until Dₖ converges; Dₖ₊₁ is the inverse of the second-order matrix of the loss function of the new iteration, xₖ₊₁ is the independent variable vector of the next iteration, xₖ is the independent variable vector of the current iteration, T is the transpose of a matrix, and/is the identity matrix.

The steps after constructing the BP neural network model include: obtaining historical original data, preprocessing the historical original data, and inputting preprocessed historical original data into the BP neural network model for training; and
preprocessing the historical original data:

$$y = ( x - u ) / σ ,$$

where y is the standardized data, x is the original data, u is the average value of the original data and σ is the standard deviation of the original data.

Obtaining the temperature compensation result of the inclinometer includes:
inputting preprocessed original data into an optimized BP neural network model, and obtaining a conversion relationship among temperature, true inclination angle and inclination angle measurement value, and obtaining the temperature compensation result of the inclinometer according to the conversion relationship.

The method for obtaining the conversion relationship among temperature, true inclination angle and inclination measurement value is as follows:

y=f(x,t),
where y is a true inclination value, x is an output value of the inclinometer, t is the temperature, and f is a relation function learned by neural network.

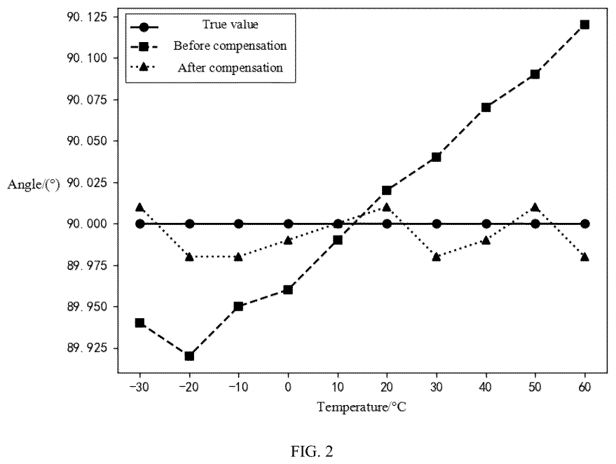

As shown in FIG. 2, the verification effect: after the model training is completed, the relationship among the temperature, the true inclination angle and the inclination angle measurement value is obtained (105). The inclinometer is placed in a three-axis temperature control turntable, and the turntable is used to adjust the inclination angle to 90°, and then the temperature is gradually adjusted from −30° C. to 60° C., and the inclinometer is allowed to stand for 30 min every 10° C. increase, and the temperature and inclination angle measurement value are collected. After the data acquisition is completed, the neural network model is used for temperature compensation. The inclination data before and after compensation are compared, and the data after compensation using neural network model has higher precision (106).

The above-mentioned embodiments only describe the preferred mode of the present disclosure, and do not limit the scope of the present disclosure. Under the premise of not departing from the design spirit of the present disclosure, various modifications and improvements made by ordinary technicians in the field to the technical solution of the present disclosure should fall within the protection scope of the present disclosure.

What is claimed is:

1. A high-precision inclinometer temperature compensation method, comprising:
acquiring original data of an inclinometer; and
inputting the original data into a back propagation neural network model to obtain a temperature compensation result of the inclinometer, wherein the back propagation neural network model is obtained by training a training set, and the training set comprises an inclination value of the inclinometer, temperature and a corresponding inclinometer measurement value, and the back propagation neural network model is optimized by adopting Limited-Broyden Fletcher Goldfarb Shanno iterative optimization algorithm.

2. The high-precision inclinometer temperature compensation method according to claim 1, wherein the training set further comprises preprocessing the training set before training: standardizing data in the training set by using Z-Score standardization method.

3. The high-precision inclinometer temperature compensation method according to claim 1, wherein constructing the back propagation neural network model comprises:
setting a number of input nodes, a number of output nodes and a number of hidden layer nodes of the back propagation neural network model, taking MSE mean square error as a loss function of the back propagation neural network model, and adopting Rectified Linear Unit function as an activation function of the back propagation neural network model.

4. The high-precision inclinometer temperature compensation method according to claim 3, wherein a method of taking the MSE mean square error as the loss function of the back propagation neural network model is:
$$E = \frac{1}{n} {\sum }_{k = 1}^{n} {( {y}_{k} - {T}_{k} )}^{2} ,$$
wherein E is an error, n is a number of training samples, yₖ is a predicted value, and Tₖ is a true value.

5. The high-precision inclinometer temperature compensation method according to claim 3, wherein a method of adopting the Rectified Linear Unit function as the activation function of the back propagation neural network model is:
f(x)=max(0,x),
wherein f(x) is an output of the Rectified Linear Unit function, and x is an input value of the function.

6. The high-precision inclinometer temperature compensation method according to claim 1, wherein after constructing the back propagation neural network model, comprising:
obtaining historical original data, preprocessing the historical original data, and inputting preprocessed historical original data into the back propagation neural network model for training; and
preprocessing the historical original data:
$$y = ( x - u ) / σ ,$$
wherein y is standardized data, x is original data, u is an average value of the original data, and σ is standard deviation of the original data.

7. The high-precision inclinometer temperature compensation method according to claim 1, wherein obtaining the temperature compensation result of the inclinometer comprises:
inputting preprocessed original data into an optimized back propagation neural network model, and obtaining a conversion relationship among temperature, a true inclination angle and an inclination angle measurement value, and obtaining the temperature compensation result of the inclinometer according to the conversion relationship.

8. The high-precision inclinometer temperature compensation method according to claim 7, wherein the conversion relationship among the temperature, the true inclination angle and the inclination angle measurement value is:
y=f(x,t),
wherein y is a true inclination value, x is an output value of the inclinometer, t is the temperature, and f is a relation function learned by neural network.
